(19) United States
(12) Patent Application Publication
(10) Pub. No.: US 2009/0107915 A1
(43) Pub. Date: Apr. 30, 2009

(54) TREATMENT PROCESS AND SYSTEM FOR WASTEWATER, PROCESS WATERS, AND PRODUCED WATERS APPLICATIONS

(75) Inventors: Harry O. Skinner, Katy, TX (US); Gregory L. Grimme, Katy, TX (US)

Correspondence Address: CONLEY ROSE, P.C.;David A. Rose, P. O. BOX 3267, HOUSTON, TX, 77253-3267, US

(73) Assignee: ITS ENGINEERED SYSTEMS, INC., Katy, TX (US)

(21) Appl. No.: 12/046,178

(22) Filed: Mar. 11, 2008

Related U.S. Application Data
(60) Provisional application No. 60/894,328, filed on Mar. 12, 2007.

(51) Int. Cl. C02F 1/44; C02F 1/463; C02F 1/24; C02F 103/00; B01D 65/02

(52) U.S. Cl. 210/636; 210/748; 210/650; 210/652; 210/703; 210/739; 210/150; 210/151

(57) ABSTRACT

A method for the removal of contaminants from a contaminated water stream, by pretreating the contaminated water stream to yield a pretreated water stream, wherein pretreating comprises passing the contaminated water stream to at least one electrocoagulation cell wherein coagulation of contaminants is promoted, yielding an electrocoagulated stream; and separating coagulated contaminants from the electrocoagulated stream.

An electrocoagulation reactor comprising a plurality of electrodes positioned parallel to each other and provided with a means of energizing each electrode; a fluid inlet for an inlet stream comprising contaminated water; a fluid outlet for an outlet stream comprising electrocoagulated products; a flow distributor system; and a gas distribution system for injecting a gas into the electrocoagulation reactor. An electrocoagulation system for treating a contaminated water stream, the system comprising at least one electrocoagulation reactor.

### CROSS-REFERENCE TO RELATED APPLICATIONS

This application claims the benefit under 35 U.S.C. § 119(e) of U.S. Provisional Patent Application Nos. 60/894,328 filed Mar. 12, 2007, and entitled, “Treatment Process and System for Wastewater, Process Waters, and Produced Waters Applications.”

### STATEMENT REGARDING FEDERALLY SPONSORED RESEARCH OR DEVELOPMENT

Not applicable.

### BACKGROUND OF THE INVENTION

1. Field of the Invention

This disclosure relates to water treatment systems and to processes for removing contaminants from contaminated water streams. More particularly, the disclosure relates to water treatment systems and processes in which electrocoagulation and associated systems are used in place of chemical treatment systems in a pretreatment zone prior to membrane separation systems of the treatment zone.

2. Background of the Invention

Contaminated water sources being considered for treatment and purification present unique challenges which must be considered in the design of water treatment processes. For example, well waters may contain high hardness, iron, etc.; surface waters may have high turbidity, high organic loading, temperature variation, etc.; process and waste waters may contain oils, greases, metals, high suspended solids, etc. The combinations of contaminants in the sources are numerous as are the combinations of treatment processes which may be implemented in a successful treatment system. Often, a number of processes are required to obtain finished water of a desired purity from a given contaminated feed water source. Conventional treatment processes may include chemical treatments, filtration, ion exchange, membrane processes, and a myriad of others. A successful water treatment system includes processes which, when correctly applied, meet the water treatment challenges in terms of water recovery, water purity, etc.

Treatment systems and processes for application to contaminated feed water sources such as industrial waste waters, process waters and oil field “produced” waters often require processes tailored to address the presence of oils and greases, high turbidity and suspended solids, high dissolved solids and other contaminants. Combinations of conventional water treatment processes which have been evaluated for these more difficult treatment applications have resulted in degrees of success ranging from failure to marginal acceptability in efficiency and economical operation.

For produced water applications, for example, a number of pilot plant studies have been conducted which combine water treatment processes into an operating system. Some typical operating systems are: (1) aeration, chemical precipitation and flocculation (lime softening), diffused air flotation (DAF), walnut shell filtration, activated carbon filtration, cation exchange (softening), and reverse osmosis (RO); (2) ozonation, media filtration, activated carbon filtration, and reverse osmosis; and (3) membrane ultrafiltration, membrane “nanofiltration,” and brackish (or seawater) reverse osmosis.

A number of other combinations of conventional processes have been evaluated as well as a number of somewhat less conventional technologies such as enhanced coagulation using ultrasonic cavitation. In most cases, technical difficulties and economics have prevented these process systems from being viable as large scale treatment methods.

Other attempts at successfully treating “produced” water from oil-producing installations have combined these “conventional” pretreatment processes into treatment systems to meet the challenges that can be expected in treating oilfield “produced” water. These examples of treatment systems are combinations of processes which may have some success on a given water source, but have experienced operational difficulties due to variations in the “produced” water characteristics, high cost of consumables, the labor intensive nature of the process, and the susceptibility to process upsets during operations.

Accordingly, an ongoing need exists for an efficient and economical system and method for large-scale treatment of contaminated waters including, but not limited to, industrial waste waters, process waters, and oilfield “produced” waters.

### BRIEF SUMMARY OF SOME OF THE PREFERRED EMBODIMENTS

A method for the removal of contaminants from a contaminated water stream, the method comprising: pretreating the contaminated water stream to yield a pretreated water stream, wherein pretreating comprises passing the contaminated water stream to at least one electrocoagulation cell wherein coagulation of contaminants is promoted, yielding an electrocoagulated stream; and separating coagulated contaminants from the electrocoagulated stream. The method may further comprise treating the pretreated water stream to yield a purified water stream, wherein treating comprises passing the pretreated water stream through at least one membrane separator. In embodiments, the overall recovery of purified water is greater than 25 volume % of the contaminated water stream.

Passing the pretreated water stream through at least one membrane separator may comprise passing the pretreated water stream through an ultrafiltration membrane separator comprising at least one ultrafiltration membrane to yield an ultrafiltrate stream. The at least one ultrafiltration filter may be periodically backwashed, yielding an ultrafiltration backwash stream. The ultrafiltration backwash stream may be recycled to the at least one electrocoagulation cell.

The method may further comprise passing the ultrafiltrate stream through a GAC filter to yield a GAC filtrate stream. The GAC filter may be periodically backwashed, yielding a GAC backwash stream. The GAC backwash stream may be recycled to the at least one electrocoagulation cell. In embodiments, the GAC filtrate stream is passed through at least one membrane separator. The at least one membrane separator may be selected from the group consisting of nanofiltration separators, reverse osmosis membrane separators, and combinations thereof.

In embodiments of the method for the removal of contaminants from a contaminated water stream, the contaminated water stream is selected from the group consisting of oilfield produced waters, industrial wastewater, process waters, and combinations thereof. The method may be used for the large scale removal of contaminants from the contaminated water stream. In embodiments, the at least one membrane separator is selected from the group consisting of ultrafiltration membrane separators, GAC filters, reverse osmosis separators, nanofiltration separators, and combinations thereof. In embodiments, removal of the contaminants from the contaminated water stream is accomplished in the absence of chemical clarification.

In some embodiments of the method for the removal of contaminants from a contaminated water stream, pretreating further comprises at least one step selected from the group consisting of: deaerating the electrocoagulated stream, flotating coagulated contaminants, flocculating coagulated contaminants, and combinations thereof. Separating coagulated contaminants from the electrocoagulated stream may comprise passing the electrocoagulated stream through a solids/liquid separator. In embodiments, the solids/liquid separator is a parallel plate clarifier.

In some embodiments, the method for the removal of contaminants from a contaminated water stream further comprises providing at least two electrocoagulation cells, wherein each of the at least two electrocoagulation cells has 100% capacity and wherein one of the at least two electrocoagulation cells is online when another of the at least two electrocoagulation cells is offline, and wherein passing the contaminated water stream to at least one electrocoagulation cell comprises passing the contaminated water stream to the online electrocoagulation cell. The method may further comprise periodically performing an automated cleaning cycle of the online electrocoagulation cells comprising: placing the electrocoagulation cell to be cleaned offline; placing one of the at least one offline electrocoagulation cells online; and placing the electrocoagulation cell to be cleaned in an automated cleaning cycle.

In some embodiments of the method for the removal of contaminants from a contaminated water stream, the at least one electrocoagulation cell comprises at least one system selected from the group consisting of air distribution systems, internal flow distribution systems, internal process fluid recirculation systems, and combinations thereof.

The method for the removal of contaminants from a contaminated water stream may further comprise providing instrumentation for the monitoring and automatic control of the at least one electrocoagulation cell. The method for the removal of contaminants from a contaminated water stream may comprise providing instrumentation for control of at least one operational parameter selected from the group consisting of: automated DC voltage control, polarity reversal of the electrodes in the at least one electrocoagulation cell, recirculation of the process liquid, initiation and control of cleaning cycles, control of inlet feed flow rate, and combinations thereof. The method for the removal of contaminants from a contaminated water stream may comprise providing instrumentation for monitoring at least one process parameter selected from the group consisting of: inlet feed flow rate to the at least one electrocoagulation cell, fluid conductivity of the inlet feed to the at least one electrocoagulation cell, fluid turbidity of the inlet feed to the at least one electrocoagulation cell, inlet fluid temperature of the inlet fluid to the at least one electrocoagulation cell, ORP of the inlet fluid to the at least one electrocoagulation cell, ORP of the effluent from the at least one electrocoagulation cell, pH of the inlet fluid to the at least one electrocoagulation cell, pH of the effluent from the at least one electrocoagulation cell, cell current, cell voltage, and combinations thereof.

Also disclosed herein is an electrocoagulation reactor comprising: a plurality of electrodes positioned parallel to each other and provided with a means of energizing each electrode; a fluid inlet for an inlet stream comprising contaminated water; a fluid outlet for an outlet stream comprising electrocoagulated products; a flow distributor system; and a gas distribution system for injecting a gas into the electrocoagulation reactor. The reactor may further comprise an internal process fluid recirculation loop.

Also disclosed herein is an electrocoagulation system for treating a contaminated water stream, the system comprising: at least one electrocoagulation reactor comprising: a plurality of electrodes positioned parallel to each other and provided with a means of energizing each electrode; a fluid inlet for an inlet stream comprising contaminated water; a fluid outlet for an outlet stream comprising electrocoagulated products; a flow distributor system; and a gas distribution system for injecting a gas into the electrocoagulation reactor. The electrocoagulation system may further comprise at least one membrane separator selected from the group consisting of ultrafiltration membrane separators, GAC filters, reverse osmosis separators, nanofiltration separators, and combinations thereof, and the at least one membrane separator may comprise an inlet for the pretreated water stream and a membrane separator outlet for a membrane separator outlet stream. The at least one membrane separator may comprise an ultrafiltration membrane separator, wherein the ultrafiltration membrane separator comprises at least one ultrafiltration membrane, and wherein the membrane separator outlet stream is an ultrafiltrate stream. The electrocoagulation system may further comprise a GAC filter comprising an inlet for the ultrafiltrate stream and an outlet for a GAC filtrate stream. The electrocoagulation system may further comprise at least one membrane separator having an inlet for the GAC filtrate stream and an outlet for the purified water stream. In embodiments, the purified water stream comprises at least 25 volume percent of the contaminated water stream. The electrocoagulation system may further comprise a separator for separating coagulated products from the outlet stream to produce a pretreated water stream. In embodiments, the separator is a clarifier.

Also disclosed herein is an electrocoagulation system for treating a contaminated water stream, the system comprising: at least two electrocoagulation reactors comprising: a plurality of electrodes positioned parallel to each other and provided with a means of energizing each electrode; a fluid inlet for an inlet stream comprising contaminated water; a fluid outlet for an outlet stream comprising electrocoagulated products; a flow distributor system; and a gas distribution system for injecting a gas into the electrocoagulation reactor and having an operating voltage range for promoting coagulation reactions within the contaminated water stream; wherein when one electrocoagulation reactor is online and has a measured operating voltage, the second electrocoagulation reactor is offline, and wherein the offline electrocoagulation reactor is placed online and the online electrocoagulation reactor is placed offline for cleaning when the measured operating voltage is not within the operating voltage range. In some embodiments, the electrocoagulation system further comprises an automated clean-in-place system.

The foregoing has outlined rather broadly the features and technical advantages of the present disclosure in order that the detailed description that follows may be better understood. Additional features and advantages of the apparatus and method will be described hereinafter that form the subject of the claims of this disclosure. It should be appreciated by those skilled in the art that the conception and the specific embodiments disclosed may be readily utilized as a basis for modifying or designing other structures for carrying out the same purposes of the present disclosure. It should also be realized by those skilled in the art that such equivalent constructions do not depart from the spirit and scope of the apparatus and method as set forth in the appended claims.

### BRIEF DESCRIPTION OF THE DRAWINGS

For a detailed description of the preferred embodiments of the system and method of the present disclosure, reference will now be made to the accompanying drawings in which:

FIG. 1 is a flow diagram of a water treatment system according to an embodiment of the present disclosure.

FIG. 2 is an exemplary flow diagram of a water treatment system.

FIG. 3a is a schematic of a top view of an electrocoagulation (EC) system according to an embodiment of this invention comprising two EC reactor cells.

FIG. 3b is a schematic of a front view of the electrocoagulation (EC) system of FIG. 3a.

FIG. 3c is a schematic of a side view of the electrocoagulation (EC) system of FIG. 3a.

FIG. 4 is flow diagram of a produced water treatment pilot plant according to an embodiment of the present disclosure.

FIG. 5 is a more detailed flow diagram of the coagulation reaction vessel (CRV), sludge handling and waste recycle of pretreatment zone 1 of the pilot plant of FIG. 4.

FIG. 6 is a more detailed flow diagram of treatment zone 2 of the water treatment system of the pilot plant of FIG. 4.

### DETAILED DESCRIPTION OF THE PREFERRED EMBODIMENTS

The following description is intended to include non-limiting examples of specific embodiments of the disclosed invention.

### I. Overview

Herein disclosed are a system and method for treating a contaminated water stream to reduce the level of contaminants therein, the system and method comprising electro-coagulation, hereinafter EC as a pretreatment to subsequent treatment processes, e.g. membrane separation processes, in the total water treatment system. In embodiments, the contaminated water stream comprises at least one water selected from the group consisting of industrial waste waters, process waters, oilfield “produced” waters, and combinations thereof. In embodiments, the water stream to be treated contains a number of contaminants including, but not limited to, oils and greases, emulsified and/or dissolved hydrocarbons, BTEX (benzene/toluene/ethylbenzene/xylenes) compounds, suspended solids (potentially colloidal in nature), high total dissolved solids (TDS) and combinations thereof. In embodiments, the EC system effectively promotes coagulation of particles, colloids, suspensions and/or enhances oxidation of organic compounds. The products produced via electrocoagulation can be effectively removed by subsequent separations in the water treatment system.

### II. General Discussion of the Water Treatment System (Apparatus)

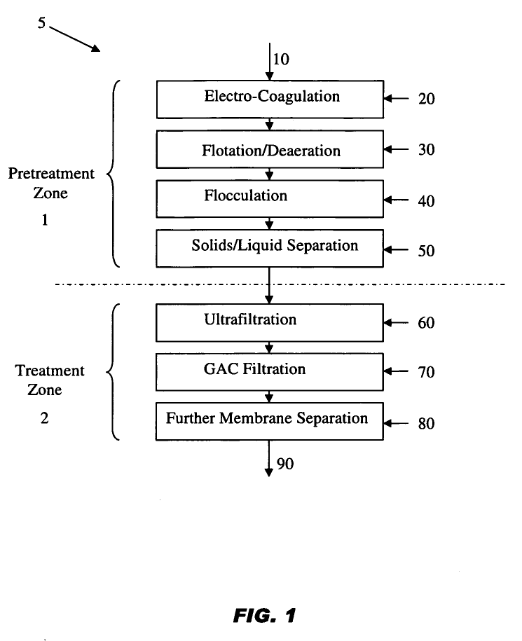

To address the combinations of contaminants in various waste water streams, combinations of treatment systems are envisioned. FIG. 1 is a general flowchart of the various treatment systems integrated in an embodiment according to the present disclosure. The water treatment system 5 of the present disclosure for treating feed water stream 10 comprises pretreatment zone 1 and treatment zone 2. Pretreatment zone 1 comprises electrocoagulation zone 20. Pretreatment zone 1 may further comprise flotation/deaeration zone 30, flocculation zone 40, solids/liquid separation zone 50, and combinations thereof. Treatment zone 2 follows pretreatment zone 1 and combines processing systems, including but not limited to membrane separation systems. In the embodiment of FIG. 1, treatment zone 2 comprises ultrafiltration (UF) system 60, granular activated carbon (GAC) filtration system 70, and further membrane separation system 80. The water treatment system of FIG. 1 yields finished water stream 90. It should be noted that some of the zones and systems shown in FIG. 1 may not be included in all embodiments of the overall water treatment plant or system. Furthermore, multiple zones exemplified in FIG. 1 may be embodied a single reactor as is known in the art. For example, a coagulation reaction vessel, further described hereinbelow, may comprise flotation/deaeration zone 30 and flocculation zone 40. Additionally, more than one reactor may comprise a zone, i.e., the zone may occur more than once in the overall water treatment process. For example, as further described hereinbelow, a flocculation zone 40 may exist within EC zone 20, a coagulation reaction vessel 200 such as those described hereinbelow, and/or a solids/liquid separator of solids/liquid separation zone 50.

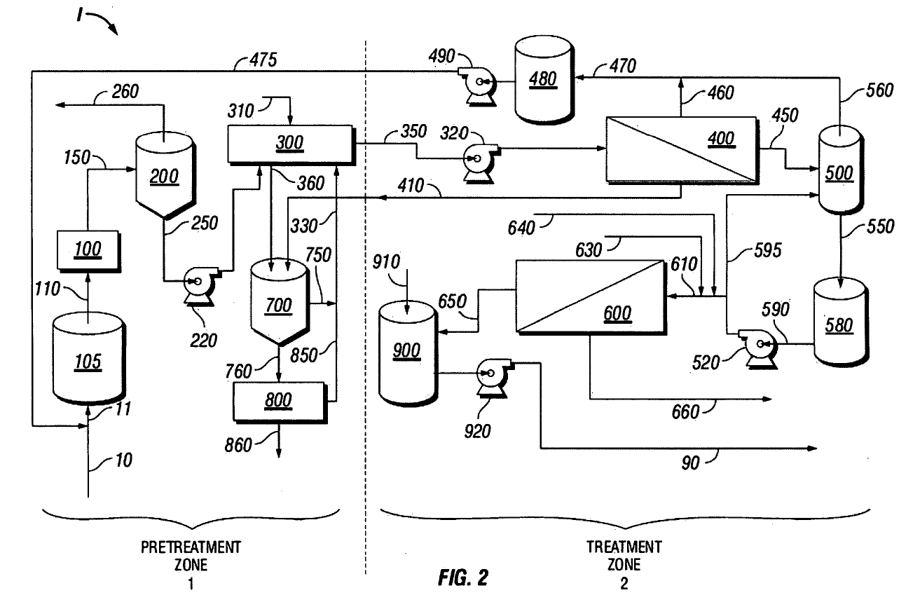

A more detailed description of an embodiment of the system and method of the present disclosure will now be made with reference to FIG. 2 which is an exemplary flow diagram of a water treatment system I. Water treatment system I of the embodiment of FIG. 2 comprises pretreatment zone 1 including, but not limited to, electrocoagulation system 100, coagulation reaction vessel (CRV) 200, and solids/liquid separation system 300. Water treatment system I further comprises treatment zone 2, which may include, for example, ultrafiltration system 400, granular activated carbon filtration system 500, membrane separation system 600, and combinations thereof. In certain embodiments, water treatment system I further comprises sludge thickener system 700, and sludge dewatering system 800. Water treatment system I may further comprise strainer 105, as well as various holding tanks such as backwash (B/W), holding tank 480 and membrane separation feed tank 580 used for backwash procedures and temporary fluid holding as understood by those of skill in the art. The systems of pretreatment zone 1 and treatment zone 2 are in fluid communication, as shown, for example, in FIG. 2 and further described hereinbelow.

### A. Electro-Coagulation System

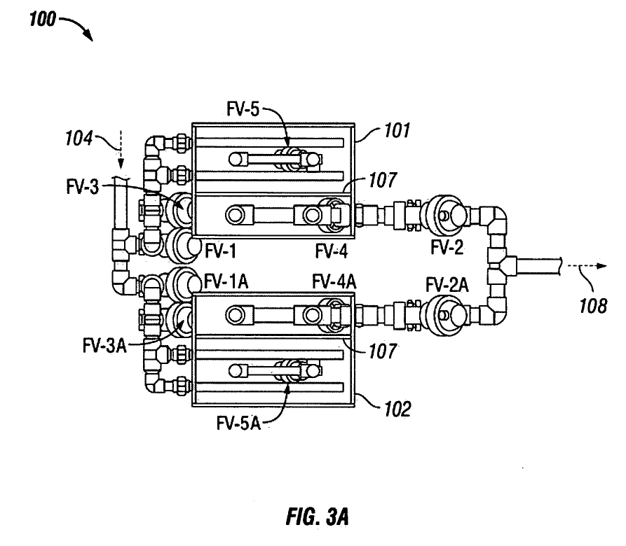

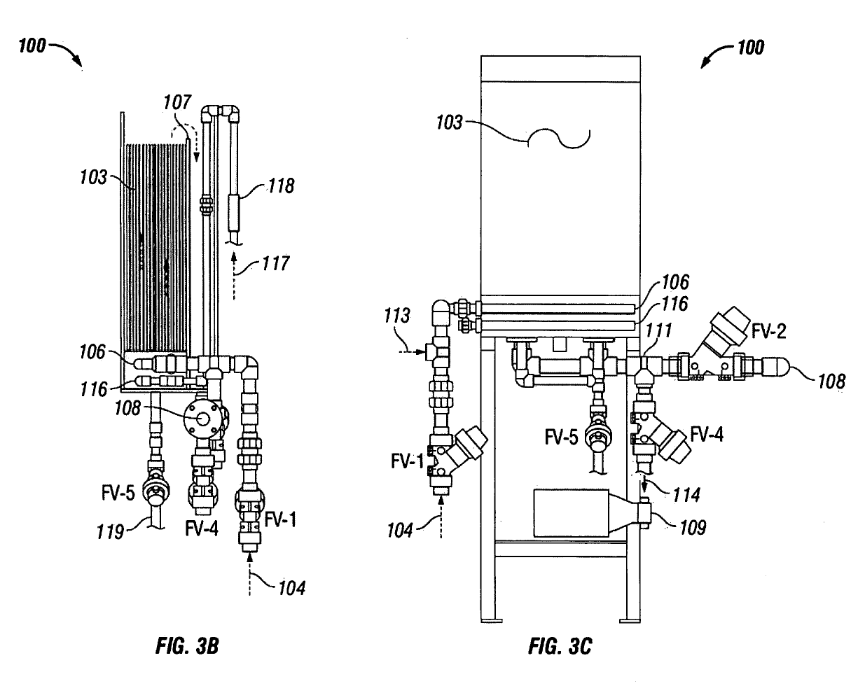

In embodiments, electrocoagulation (EC) system 100 of pretreatment zone 1 of water treatment system I comprises conventional electrochemical electrocoagulation reactor cell(s). Alternatively, EC system 100 comprises an EC reactor cell(s) incorporating a number of unique and novel features into the conventional design of an electrochemical reactor cell. A description of a suitable EC reactor cell for use in the system and method of the present disclosure will now be given with reference to FIGS. 3a-3c which are, respectively, schematics of top (FIG. 3a), front (FIG. 3b), and side (FIG. 3c) views of an EC system 100 comprising two EC reactor cells 101 and 102.

1. Reactor Cell(s)

As shown in FIG. 3a, EC system 100 comprises two EC reactor cells 101 and 102. Although the EC system 100 of FIGS. 3a-3c comprises two EC reactor cells 101 and 102, any number of EC reactor cells is envisioned. EC reactor cell(s) 101 and 102 comprise electrodes 103 arranged so that, as fluid to be treated passes through EC reactor cell(s) 101 and 102 and a voltage is applied to the EC electrodes 103 in reactor cell(s) 101-102, reactive metal ions are released into the fluid, promoting electrochemical reactions which initiate coagulation of particles, colloids, etc., and the formation of insoluble precipitates. Process fluid chemistry, contaminants, and constituents, electrode materials, operating parameters, and other factors determine the numerous chemical reactions and the resulting products that occur within the EC reactor cell(s). These reactions include, without limitation, oxidation/reduction reactions which result in the oxidation of organics and promote the coagulation of various insoluble compounds produced by the release of reactive metal ions from the sacrificial electrodes 103 of the EC cells 101 and 102.

In some embodiments, electrodes 103 are positioned parallel to each other and are equally spaced. The number of electrode plates 103 and the spacing of electrode plates 103 are determined by, among other parameters, the cell-designed operational throughput flow, residence time required in the EC cell, characteristics of the process fluid, type and quantity of contaminants to be addressed, as is known to one of skill in the art. The electrode materials used in the EC reactor cell(s) may include iron, aluminum, stainless steel, other metals, or a combination of metals. Preferentially, the electrode comprises iron, although other metals or combinations of metals may be used for specific applications. In embodiments, the electrode material is carbon steel. In embodiments, the EC cell(s) comprises 25 plates each. In embodiments, the plate spacing is from about 0.25″ to about 0.375″.

2. Internal Flow Distributor System & Reactor Cell Internal Recirculation

In embodiments, each EC reactor cell is designed such that process fluid introduced into the cell via EC system inlet 104 and an EC cell inlet flow valve is directed through the cell in channels that are formed by the electrode plates 103 in a flow pattern and at a velocity that ensures a turbulent flow within the channels of the electrode plates 103, as described further hereinbelow. For example, in the embodiment of FIG. 3a, process fluid enters EC reactor cells 101 and 102 via EC cell inlet flow valves FV-1 and FV-1A. Process fluid exits the EC cells via EC cell outlets 108, the flow rate of each of which is controllable by an EC cell outlet flow valve. For example, in the embodiment of FIG. 3a, the flow rates of the process fluid exiting EC reactor cells 101 and 102 are controllable by EC cell outlet flow valves FV-2 and FV-2A, respectively. As seen in FIG. 3b, each EC reactor cell 101/102 comprises an EC cell drain 119, the flow through which is controllable via EC cell drain flow valves. For example, as seen in FIG. 3a, the flows through flow drains 119 for EC reactor cells 101 and 102 are controllable with EC cell drain flow valves FV-5 and FV-5A, respectively.

In embodiments, each EC cell 101 and 102 comprises an internal flow distributor 106 to ensure equal flow through the cell(s) and past the electrode plate surfaces. The EC process is a surface reaction between the EC electrodes 103 and the process fluid. To ensure optimum efficiency and to aid in prevention of electrode scaling and passivation, a turbulent flow within the process fluid is desirable. To ensure a turbulent flow in the fluid channels formed by the electrode plates and enhance the electrochemical reactions promoted at the electrode plate surfaces, in embodiments, the EC reactor cell(s) are designed with an internal process fluid recirculation loop. Recycle pump inlet flow valves FV-4 and FV-4A divert a portion of the process fluid from the EC system effluent piping 111 to the EC system influent piping 113 by means of recycle pump inlet 114, recycle pump 109, and recycle pump outlet flow valves FV-3 and FV-3A. In preferred embodiments, the pump(s) are of a design such as flexible impeller, diaphragm, or such which are low shear designs and minimize/prevent break up of coagulated particles which may have formed in the EC reactor cell(s). The recirculation pumps 109 are designed with the ability to provide a variable flow rate by pump or pump drive speed control.

3. Reactor Cell Air (or Other Reactive Gas) Distributor System

To ensure turbulent flow in the reactor cell electrode channels and to permit the possibility of introducing air or reactive gases into the process fluid within the cell(s), EC cells 101-102 may comprise gas distribution system 116. As part of system 116, air or gas inlet 117 and air or gas flowmeter 118 are incorporated into some embodiments of EC system 100. Gas distribution system 116 is designed into the bottom of the cell(s) for the injection of gases into the EC reactor cell(s) 101/102 to promote reactions within the EC cell(s) and/or aid in the reduction and/or the removal of contaminants specific to an application, or to enhance the coagulation process. The introduction of air or gas to the bottom of the reactor cell in the form of finely distributed bubbles also serves to encourage turbulent flow within the reactor cell and aids in the periodic cleaning procedure (further described hereinbelow) of the electrode plates 103 by producing a “scrubbing” action during the cleaning process.

A number of reactive gases are formed and released at the electrode surfaces including, but not limited to, oxygen, hydrogen, and carbon dioxide. The reactive gases produced will vary depending upon, for example, the chemical characteristics of the process fluid. EC system 100 may further comprise an exhaust system (not shown) whereby gases either produced or introduced into the EC reactor cell(s) are removed from the cell(s) to prevent accumulation of gases in the cell(s) and/or in the process area. The air or gas which is introduced into the EC reactor cells 101/102, as well as gases produced in the EC reactor cells during the electro-coagulation process may be collected in ventilation hoods incorporated into the design of the EC reactor cells and/or in a vessel, e.g., a coagulation reaction vessel, positioned downstream of the EC reactor cell(s). Gases are removed from ventilation hoods by means of an exhaust blower system and discharged to the atmosphere or directed to a “scrubber” system as required (not shown in FIGS. 3a-3c).

4. EC Reactor Cell Applied Voltage

Electrode plates (electrodes) 103 are provided with a means of energizing each plate with an applied voltage. In embodiments, a DC voltage is applied to the sacrificial electrode plates 103 of the EC reactor cell(s) 101/102 by means of a regulated silicon controlled rectifier (SCR) power supply of a capacity capable of supplying sufficient power to the electrode plates to promote the electrochemical reactions in the EC cell(s). Power requirements will vary and depend upon such factors as the process fluid chemistry, electrode materials, electrode spacing, etc., as discussed hereinabove. The SCR power supply is controlled by the EC system PLC, which is described in more detail hereinbelow. In embodiments, EC reactor cell(s) 101 (and/or 102) and the power supply are designed such that any combination of electrode plates 103 may be energized. Additionally, electrode plates 103 are designed so that polarity reversal of the electrodes may be performed at predetermined intervals to reduce or prevent “scaling” and/or passivation of the cell electrode plates during operation. EC system 100 preferably comprises automated DC voltage control to maintain proper current through the EC reactor cell(s). Proper current is desirable to promote the electrochemical reactions within the cell, and limit the electrode current density thereby preventing excessive DC current to the reactor electrodes which could passivate electrode plates 103.

5. CIP System

EC system 100 may comprise an automated “clean-in-place” (CIP) system, as further described hereinbelow, to periodically clean the electrode plates 103 of scale films or surface passivation. EC system 100 may comprise a pair (2) of electrocoagulation cells 101, 102 each having 100% capacity, such that when one cell is either in “standby” or clean-in-place, CIP, the other cell is online. Upon completion of a CIP cycle the cleaned reactor cell is placed in “standby” mode until the online cell requires CIP, at which time the “standby” cell is placed in service.

6. EC Instrumentation

EC system 100 is in communication with a programmable logic controller (PLC) which is capable of monitoring and controlling EC system 100 via instrumentation further discussed hereinbelow. The incorporation of the disparate instrumentation herein described will enhance the performance of EC system 100 and provide for more automated and efficient control of the operation of the EC reactor cell(s) 101, 102. The PLC(s) (not shown in FIG. 1) is (are) capable of receiving data from system sensors and transmitters, processing the data and controlling system operational parameters including, but not limited to: DC voltage to the EC reactor cells, feed flow to the EC reactor cell(s), recirculation of the process liquid, initiation of a CIP cycle and control of the CIP cycle steps. Process parameters monitored include, but are not intended to be limited to: the inlet feed flow rate to the EC reactor cell(s), the inlet feed fluid conductivity, the feed fluid turbidity in Nephlometric Turbidity Units (NTU), the inlet fluid temperature, the oxidation/reduction potential (ORP) of the inlet fluid (mV), and the oxidation/reduction potential (ORP) of the effluent (mV) fluid.

In embodiments, EC system 100 comprises instrumentation for the continuous measurement of the turbidity of EC influent stream 110 and the effluent stream, e.g., at solids/liquid separation system process stream 350, as shown in FIG. 2. Comparison of the turbidity levels of the influent and effluent streams provides an indication of the most efficient operational parameters which can be adjusted and controlled in EC reactor system 100. Operational parameters include, but are not limited to: cell current, electrode spacing, cell influent flow rate, internal recirculation, and air (or other gas) flow rate.

Referring again to FIG. 2, in embodiments, EC system 100 comprises means for collecting and logging influent pH/ORP data prior to EC reactor cell(s) 101/102 to enable adjustment of the influent stream pH/ORP to the optimal range for a specific process stream application. Adjustment of pH may be accomplished by any means known to those of skill in the art, for example via a chemical injection system positioned in EC system inlet 104 piping upstream of EC reactor cells 101/102 and associated piping and control valves of EC system 100.

In addition, the post EC fluid stream ORP may be compared to the influent ORP, which when evaluated in consideration of other system process parameters including, but not limited to, cell voltage, cell current, conductivity, polarity reversal frequency, and others, can provide an indication of the EC reactor cell condition and reactor efficiency. An indication of electrode scaling or passivation requiring an electrode cleaning process may also be determined from analysis of this data. Data logging and processing is performed by the PLC controlling EC system 100. Data collected and analyzed by PLC may also be “trended” to facilitate analysis of the operations of EC system 100 over time.

In embodiments, EC system 100 further comprises instrumentation for continuously collecting electrical conductivity data for the inlet process fluid and logging the data by system PLC. Such instrumentation may comprise commercially available conductivity instrumentation. The conductivity data may be used to determine electrode spacing, calculate desirable applied DC voltage, and determine applied voltage limits to the EC reactor cell(s).

EC reactor cell influent flow rate may be continuously measured, controlled and logged in the system PLC by means of a flowmeter/transmitter on EC system inlet piping 104 to the EC reactor cells 101, 102. An analog signal from the flowmeter/transmitter instrument may be fed to the system PLC which may control an inlet feed pump or modulating flow control valves, e.g. FV-1 and FV-1A, to maintain proper fluid flow through the EC reactor cells. In embodiments, cumulative fluid throughput flow volume is stored in the PLC processor data files.

Preferably, EC cell current is continuously monitored and logged in system PLC. The desired operating cell current is determined by, among other things, reactor cell electrode material, electrode current density, process fluid contaminants to be addressed for removal by EC system 100 and associated fluid/solids separations processes, and application-specific variables. Cell current is controlled by system PLC which is programmed to control the DC power supply output voltage to maintain a desired EC cell current. Upper and lower EC cell current limits are preset into PLC. In embodiments, upper current limits are set at a current density below that which will encourage electrode passivation. In embodiments, lower cell current limits are set at a level above the lowest current density which will promote the electrocoagulation process for a specific contaminant and/or application.

In embodiments, the EC cell voltage needed to maintain a predetermined and preset current through each EC cell is controlled by the system PLC. In embodiments, the applied voltage required to maintain the cell current is continuously monitored and logged in the PLC. A preferred “range” of operating applied voltage may be determined from the desired electrode current density, electrode material of construction, process fluid conductivity, electrode spacing, and other system design and operational parameters.

In embodiments, EC system 100 comprises two EC reactor cells such that when the required voltage for promoting reaction reaches a preset maximum, indicating that the cell electrodes may require a cleaning procedure, the EC reactor cell in service may be taken off line, and the redundant EC cell which is in “standby” mode may be placed in service. The EC reactor cell which was in service may be placed into an automated cleaning cycle by the system PLC. In other embodiments, EC system 100 comprises more than 2 EC reactor cells.

In embodiments, polarity reversal of the DC voltage to the EC reactor cell electrodes is automatically initiated based on a predetermined and preset time of operation of the reactor cell, or on a preset applied voltage to the reactor cell(s) setting, whichever should occur first. The applied voltage setting is determined based upon electrode construction materials, electrode spacing within the EC reactor cell, application-specific parameters such as process fluid conductivity, required electrode current density, and other operational parameters which are optimized to ensure efficient electrocoagulation activity in water treatment system I.

7. Piping and Valving

The design of the piping and valving of EC system 100 provides for the ability to perform the functions of the system including, but not limited to: control of process fluid flow through EC reactor cells 101/102, control of internal fluid flow within the EC cells 101/102 by means of the recirculation loop, injection and control of air or gases introduced into the EC reactor cell through gas distribution system 116 (in the event that it is deemed advantageous to the EC process on specific fluid treatment applications), and initiation of automated electrode cleaning procedures and control of the cleaning process cycle.

8. Contaminants Removed Via EC System

EC system 100 may serve to reduce or remove contaminants including, but not limited to, free and emulsified oils, BTEX (benzene/toluene/ethylbenzene/xylenes) compounds, volatile organic compounds (VOCs), hydrocarbons, H₂S, suspended solids, heavy metals, bacteria, and combinations thereof. The EC system 100 may serve to reduce total organic carbon (TOC), biochemical oxygen demand (BOD), total dissolved solids (TDS) or a combination thereof. The levels of reduction or removal will vary depending on the feedwater source and operation of the EC system. In embodiments, EC system 100 is capable of removing more than 98% emulsified hydrocarbons. In embodiments, EC system 100 is capable of removing more than 90% of total suspended solids. In embodiments, EC system 100 reduces dissolved solids by greater than 30%, alternatively by greater than 40%. In embodiments, EC system 100 destroys more than 99% of bacteria. EC system 100 may be capable of reducing TOC by more than 90%, alternatively by more than 95%.

### B. Coagulation Reaction Vessel

Referring again to FIG. 2, in embodiments, pretreatment zone 1 further comprises a coagulation reaction vessel, CRV, 200. Coagulation Reaction Vessel 200 receives fluid 150 from EC system 100. CRV 200 may be equipped with a low shear mixer to promote coagulated particle collision causing larger flocculant (“floc”) particles to be formed. CRV 200 is designed such that oils and floatable materials (oil and grease, O&G) which have been formed in the EC reactor cell(s) are floated and separated by periodic controlled overflow into an internal compartment in CRV 200 from which this material is pumped to appropriate handling systems. CRV 200 equipped with the low shear mixer, serves to allow the process fluid to be de-aerated and the gas bubbles which were formed in the EC reactor cell(s) and entrained in the process fluid to be released and vented through the exhaust system installed for the process gases. In embodiments in which solids/liquid separation system 300 is a settling-type clarifier, CRV 200 equipped for removal of gas bubbles provides for increased efficiency in the clarifier.

In embodiments, CRV 200 is capable of removing more than 90% of the O&G from an inlet stream.

### C. Solids/Liquid Separation System

In embodiments, pretreatment zone 1 further comprises solids/liquid separation system 300. Solids/liquid separation system 300 may comprise one or more of clarifier-type systems, diffused air flotation (DAF) systems, direct filtration units, centrifugal separators, other separation as is known to those of skill in the art as the preferable method of separation of the coagulated particles from the process stream, and any combination thereof. In certain embodiments, solids/liquid separation system 300 is a settling-type clarifier (gravity) system.

The clarifier design typically comprises a “floc” chamber (flocculation zone) at the inlet of the clarifier, into which a polymer or flocculant aid may be injected to promote “growth” of coagulated particles by reducing the surface charge of the particles, promoting aggregation of “floc” of higher density. In embodiments, the clarifier contains 2 to 3 ppm polymer to assist in the settling rate of particulates. In alternative arrangements, a flocculant aid is introduced into the “coagulated” fluid from EC system 100 in a reaction vessel (for example, CRV 200) prior to clarification or filtration of the fluid being treated by water treatment system I. The flocculant is typically either an anion polymer or cationic polymer depending on the characteristics of the feedwater and the operating conditions of EC system 100.

Solids/liquid separation system 300 may include means for low shear mixing for promoting floc formation of the process fluid to which the polymer has been added. In embodiments, the solids/liquid separation system 300 is designed such that fluid is directed from the floc tank section into a settling section of the clarifier. The clarifier is preferably sized for water treatment system I to provide for a loading factor of not more that 0.25 GPM/square foot of effective settling surface. The preferred design of the clarifier is an inclined plate design. In embodiments, the clarifier is a parallel plate clarifier. Commercially available clarifier systems or clarifier designs may be used in the treatment system clarification process step.

As mentioned hereinabove, solids/liquid separation system 300 is in communication with a system for measuring and monitoring, for example, the turbidity of the effluent of the clarifier (solids/liquid system process stream 350) whereby operating conditions and parameters for solids/liquid separation system 300 are adjusted, set and controlled.

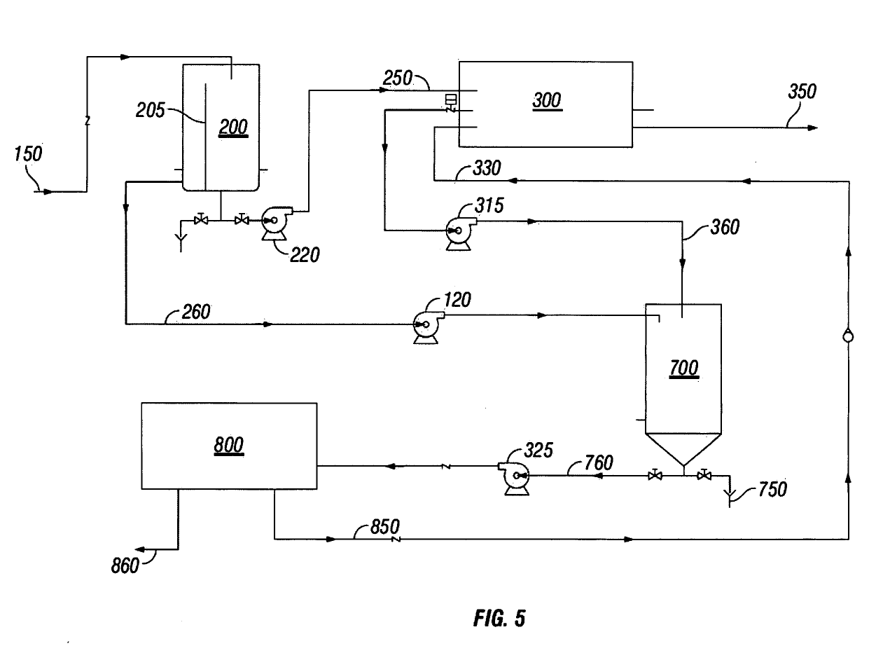

The clarifier may be designed such that precipitated solids which have been formed in EC system 100 and settled in the settling section of solids/liquid separator 300 may exit the bottom of solids/liquid separator 300 as a sludge 360 for subsequent transferal to sludge thickening vessel 700 by means of a low shear design pump (floated suspended solids pump 120 FIG. 5) such as a progressive cavity, flexible impeller, diaphragm pump, or similar type design.

In embodiments, flocculated suspended solids removal effected by the clarifier is greater than 85%, alternatively greater than 90%, alternatively greater than 99%. In embodiments, the precipitated dissolved solids removal effected by the clarifier is greater than 85%, alternatively greater than 90%, alternatively greater than 99%.

### D. Sludge Thickener System

In embodiments, sludge thickener system 700 is incorporated into water treatment system I to thicken sludge 360 from solids/liquid separation system 300 (e.g., clarifier) prior to sludge dewatering 800. For small to medium sized systems, sludge thickener system 700 may be, as shown in FIG. 2, in the form of a conical-bottomed vessel. The unit is designed such that sufficient retention time is given to allow for separation of the precipitated solids from the process fluid which has been transferred with the sludge 360 from solids/liquid separation system 300. Sludge thickener system 700 may be designed such that a polymer with properties which promote “dewatering” of the sludge may be injected into sludge thickener system 700 to assist in producing a sludge of higher solids content prior to transferral of the sludge to a further separation system such as a filtering system, centrifugal separator, etc. Alternatively, on large systems which produce a large amount of sludge in the primary clarifier 300, a secondary clarifier may be employed in conjunction therewith to more efficiently produce a sludge of higher solids content.

In embodiments, sludge thickener system 700 produces a thickened sludge 760 with greater than 5% solids.

### E. Sludge Dewatering System

Sludge dewatering system 800 serves to dewater sludge produced within water treatment system I and settled in solids/liquid separation system 300 and sludge thickener system 700 to produce a sludge “cake” of very high solids content. The sludge “cake” can then be sent to sludge handling 860. The sludge “cake” may then be disposed in a proper manner such as landfill, incineration, etc., depending on the characteristics of the sludge produced and site requirements. Sludge dewatering system 800 preferably consists of a filter press or similar system capable of extracting the water from the sludge to produce a high solids “cake”.

In embodiments, sludge dewatering system 800 produces a sludge cake of greater than 12% solids, alternatively greater than 20% solids, alternatively greater than 25% solids.

### F. Ultrafiltration System

As mentioned hereinabove, water treatment system I further comprises treatment zone 2, which may include, for example, ultrafiltration system 400, granular activated carbon filtration system 500, membrane separation system 600, and combinations thereof. In embodiments, treatment zone 2 comprises ultrafiltration system 400. Ultrafiltration system 400 is incorporated to treat the process stream prior to membrane separation system 600 such as nanofiltration (NF), or reverse osmosis (RO). In these embodiments, removal of contaminants by UF system 400 enables improved recovery and membrane flux in the NF/RO system. In embodiments, UF system 400 receives the effluent process fluid 350 from solids/liquid separator 300.

In embodiments, ultrafiltration system 400 comprises filter elements of backwashable, spiral-wound filters comprising polyacrylonitrile membranes. Suitable ultrafiltration systems and methods for operation are described, for example, in U.S. patent application Ser. No. 11/588,756, hereby incorporated herein by reference in its entirety for all purposes. Ultrafiltration pump 320 serves to send solids/liquid separator effluent 350 to ultrafiltration system 400 comprising ultrafiltration modules. In embodiments, ultrafiltration system 400 comprises a plurality of ultrafiltration modules, for example, a plurality of spiral wound ultrafiltration membranes. In certain embodiments, ultrafiltration system 400 comprises four ultrafiltration modules. Ultrafiltration backwash holding tank 480 serves to retain B/W water from UF system 400, as described hereinbelow.

In embodiments, ultrafiltration system 400 is designed such that turbidity is reduced to less than 0.1 NTU (nephlometric turbidity units). In embodiments, ultrafiltration system 400 is designed such that the silt density index (SDI) is reduced to less than 2.0.

### G. GAC Filtration

In certain arrangements, granular activated carbon (GAC) filter bed 500 is incorporated into treatment zone 2 to receive the effluent filtrate 450 from UF system 400 prior to further processing by, for example, membrane separation system 600. In addition, the GAC bed 500 may remove any potential carryover of organic compounds (e.g., trace BTEX carryover) from process fluid which has been processed by electrocoagulation system 100 and ultrafiltration system 400 in water treatment system I. In embodiments of water treatment system I in which membrane separation system 600 comprises an RO system of brackish water membrane or seawater membrane design, granular activated carbon (GAC) bed 500 may serve to remove free and residual chlorine which may carry over from, for example, UF system 400 following a chemical enhanced backwash of the UF membranes.

The GAC filter may comprise typical industrial design back-washable carbon filter, the carbon media preferably being a high quality, acid washed coconut-based carbon.

### H. Reverse Osmosis System

If the requirements of the treated process fluid include a reduction of dissolved solids or separation of high molecular weight components, treatment zone 2 may further comprise membrane separation system 600, which may comprise, for example, a nanofiltration (NF) or reverse osmosis (RO) membrane system. If an RO system is incorporated to meet purity requirements, the design of the RO system and the membrane type chosen will depend on the total dissolved solids (TDS) of the process fluid and/or the quality requirement of the end product treated fluid. Preferably a nanofiltration or reverse osmosis system designed with conventional thin-film-composite (TFC) membrane material in a “spiral wound” configuration is a part of the treatment system, as is known in the art.

In certain arrangements, membrane separation system 600 comprises a NF system, and removal of TDS is greater than or equal to about 80% in the NF system. In alternative arrangements, membrane separation system 600 comprises an RO system, and removal of TDS is greater than or equal to about 96% in the RO system.

### I. SAR Adjustment System

Depending on the intended usage of finished water 90, it may be desirable to adjust the sodium adsorption ratio (SAR) of the treated water, as is known in the art. High concentrations of sodium ions will affect the permeability of soil and may lead to infiltration problems if the water is discharged on the soil. Hence, when finished water 90 is intended for surface discharge, irrigation for example, it may be desirable to include SAR adjustment system 900. SAR expresses the relative concentration of sodium to calcium and magnesium as known in the art. In embodiments, SAR adjustment system 900 reduces SAR to less than 3.0 for surface discharge.

### III. Process

Description of a process for treating a feed water stream will now be made with reference to FIG. 2. In embodiments, feed water stream 10 is combined with recycle stream 475 to produce inlet feed stream 11. Feed water stream 10 may be treated prior to introduction as stream 110 into EC system 100. For example, in embodiments, strainer 105 is used to remove contaminants from feed water stream 11. As mentioned above, in certain embodiments, EC system 100 comprises two electrocoagulation cells and a CIP system. In embodiments, CIP is initiated when the automatically controlled voltage required to maintain the proper electrode current density increases to a predetermined set-point as detected by the PLC(s). Upon initiation of the CIP cycle, the online cell is taken offline and the alternate cell is placed online. The “dirty” cell is automatically drained of process fluid, a cleaning solution such as phosphoric acid, sulfamic acid, or other acids from an acid reservoir (not shown), is introduced into the cell, recirculated for a pre-determined time and pumped or directed to the process system holding tank (not shown) for dilution and recycle to inlet feed stream 11 of water treatment system I as a small percentage of feed water 10.

Following a residence time, preferably greater than one (1) minute in the reactor cell(s) of EC system 100, the process fluid is directed via EC system exit stream 150 to the coagulation reaction vessel (CRV) 200 where the coagulation process is given time for completion and gases which have been formed in/or introduced into the EC reactor cell(s), are released and are removed by a ducted ventilation system (not shown). The residence time in CRV 200 is chosen such that time is sufficient for completion of coagulation initiated in EC system 100, deaeration, and flotation of O&G, as is known in the art. In embodiments, residence time in CRV 200 is in the range of from three to five minutes during which time the fluid is mixed with a low shear mixer.

CRV exit process stream 250 is pumped via coagulation reaction vessel pump 220 to solids/liquid separation system, 300. Coagulation reaction vessel pump 220 comprises a low shear type pump such as a progressive cavity pump, flexible impeller pump, or similar designs of pumps. Process fluid is pumped from CRV 200 to solids/liquid separation system 300 wherein the coagulated particles are separated from the process stream. Flocculant stream 310 comprising flocculant may be injected into the “floc” zone of solids/liquid separation system 300. Flocculant may be injected to a level in the range of from about 1 ppm by wt to about 10 ppm by wt. Residence time in the floc zone of solids/liquid separator 300 (e.g., clarifier) may be in the range of from about three (3) to about five (5) minutes, alternatively, the residence time is adjusted to allow adequate duration to promote flocculation. When operated at a constant through flow rate, addition of flocculant 310 may be set at a fixed injection pump rate to provide correct polymer dosage to the process fluid.

Solids/liquid separation system sludge stream 360 is sent via sludge thickener system 700 and sludge thickener sludge exit stream 760 to sludge dewatering system 800. Decant from the sludge in sludge thickener system 700 is recycled via sludge thickener recycle stream 750. Sludge thickener sludge exit stream 760 enters dewatering system 800, e.g. a filter press, wherein a dewatered sludge cake for disposal 860 is produced. Decant from dewatering system 800 is recycled via dewatering system recycle stream 850, and sludge dewatering recycle stream 330 to solids/liquid separation system 300. CRV exit sludge stream 260 may also be introduced into sludge thickener 700. Sludge may be removed on a periodic basis as required depending on the volume which is produced from a particular process fluid stream.

In embodiments, solids/liquid separation system process stream 350 is transferred either by gravity flow or by pumping to a holding tank with sufficient volume to serve as a buffer or surge tank for subsequent processing systems, preferably membrane separations processes, in treatment zone 2. In the embodiment of FIG. 2, solids/liquid separation system process stream 350 is sent via ultrafiltration pump 320 to ultrafiltration system 400. During backwash operations, backwash stream 410 may be sent via a strainer (not shown) to sludge thickener system 700.

UF fluid process stream 450 enters GAC filtration system 500. GAC exit fluid stream 550 may be stored in membrane separation system feed tank 580. Process fluid is pumped through the GAC filter bed by means of ultrafiltration pump 320 on UF system 400 in normal service mode and to membrane separation system feed tank 580 with sufficient volume to serve as a buffer or surge tank in the process system. Membrane separation system feed tank 580 must also be of sufficient volume to provide for backwash of GAC carbon filter bed 500. Periodic backwash of GAC carbon filter bed 500 is accomplished by means of the membrane separation system feed tank pump 520 with ultrafiltered and carbon filtered fluid which has been stored in the membrane separation system feed tank 580. GAC backwash stream 560 from the carbon filter is directed to backwash holding tank 480 to be recycled to inlet feed stream 11 to water treatment system I to be treated with UF backwash stream 460 from ultrafiltration system 400. GAC backwash stream 560 and UF backwash stream 460 enter backwash holding tank 480 via stream 470, from which they may be recycled via backwash recycle pump 490 and backwash recycle stream 475 to strainer 105.

Membrane separation system feed tank exit fluid stream 590 is pumped via membrane separation system feed tank pump 520 and membrane separation system inlet stream 610 to membrane separation system 600. Antiscalant may be injected into membrane separation system 600 to reduce scaling of the apparatus via antiscalant stream 630 and membrane separation system inlet stream 610. The pH within membrane separation system 600 may be adjusted as is known to those in the art via pH adjustment stream 640 and membrane separation system inlet stream 610. In embodiments, pH adjustment stream 640 comprises sulfuric acid. During GAC backwash, a portion of membrane separation system feed tank exit fluid stream 590 is diverted via GAC backwash stream 595 to GAC filtration system 500. Membrane separation system reject stream 660 is sent for disposal.

In embodiments, membrane separation system permeate stream 650 enters SAR adjustment system 900. SAR adjustment stream 910, comprising, for example, calcium oxide or calcium hydroxide, enters SAR adjustment system 900. Finished water stream 90 may be pumped from water treatment system I via pressure pump 920.

The disclosed water treatment system has many benefits over a conventional chemical treatment system, particularly in the “pretreatment” of the produced water prior to membrane systems. In embodiments, the methods of the present disclosure effect water treatment with virtual elimination of chemical requirements related to the coagulation/flocculation process. In embodiments, the proposed system and methods eliminate the chemical requirements with respect to pH adjustments to achieve clarification. Additionally, embodiments of the present disclosure may address a wider variety of contaminants than chemical clarification. The methods of the present disclosure may reduce the amount of sludge that requires handling and disposal. In embodiments, the sludge produced via the system and methods herein disclosed is acceptable for landfill. In embodiments, recycle of process streams is incorporated as described herein to reduce the volume of “reject” fluid that requires disposal. For example, recycle of streams including, but not limited to, UF backwash stream 460 and GAC backwash stream 560 may reduce the volume of “reject” produced by the process. The present methods and system may also reduce labor requirements for operations. In embodiments, the water treatment system herein disclosed may decrease capital costs and/or reduce the equipment footprint when compared with conventional systems.

In embodiments, the herein disclosed water treatment method and system may be used to attain an overall water recovery of greater than 25% by volume of feed water stream 10. Alternatively, the herein disclosed water treatment method and system may be used to attain an overall water recovery of greater than 50% by volume of feed water stream 10. Alternatively, the herein disclosed water treatment method and system may be used to attain an overall water recovery of greater than 75% by volume of feed water stream 10. Overall recovery is defined herein as the volumetric flow rate (gal/min) of purified water (finished water stream 90) produced by the process divided by the flow rate (gal/min) of the contaminated incoming feed stream (feed water stream 10).

### EXAMPLES

### Example 1

### 20 GPM Feed Water Treatment Pilot Plant

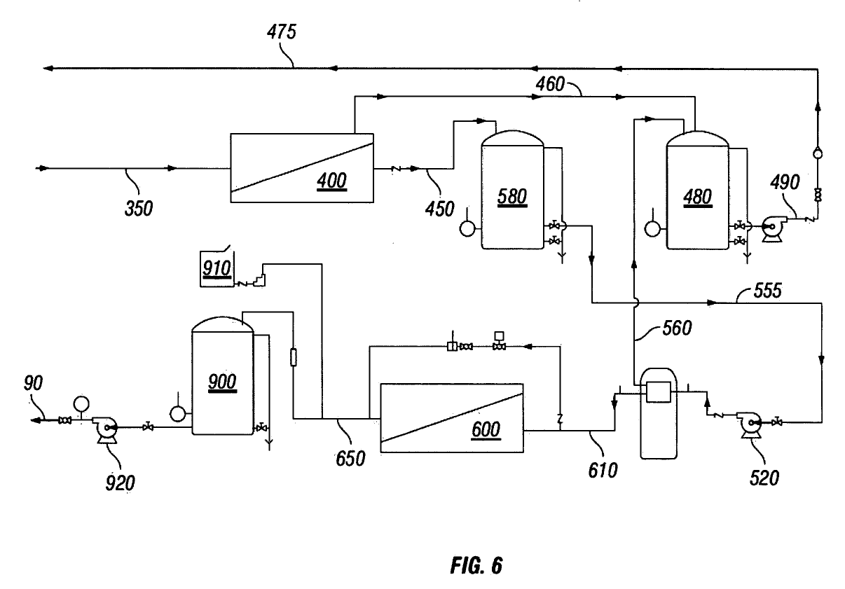

A water treatment system in accordance with the present disclosure was designed with a 20 GPM feed produced water stream 10. Description of the water treatment pilot plant II will now be made with reference to FIGS. 6, 7 and 8. Feed water stream 10 at 20-21 GPM and backwash recycle stream 475 at about 2 GPM enter strainer 105 via inlet feed stream 11. Strainer outlet stream 110 enters EC system 100. In this embodiment of EC system 100, the EC system comprises two electro-coagulation cells 101 and 102. EC system exit stream 150 at a flow rate of about 21.5 GPM is sent to CRV 200.

A more detailed flow diagram of CRV 200 operation, sludge handling and waste recycle of pretreatment zone 1 of the pilot plant is presented in FIG. 5. In this embodiment, CRV 200 comprises 20 gallon HDPE tank and impeller 205. Retention in CRV 200 is greater than 5 minutes to allow for deaeration, completion of coagulation, and flotation. CRV exit sludge stream 260 is sent via floated suspended solids pump 120 to sludge thickener system 700.

CRV exit process stream 250 is sent via CRV pump 220 at 22 GPM to solids/liquid separation system 300, which is a 25 GPM slant plate clarifier having a rise rate of less than 0.25 GPM per square foot. Solids/liquid separation system sludge stream 360 is sent via sludge transfer pump 315 to sludge thickener system 700. In this pilot plant, sludge thickener system 700 comprises a 200 gallon HDPE cone-bottomed tank and sludge transfer pump 315 comprises a 30 GPM flex impeller pump. Sludge thickener sludge exit stream 760 is sent via sludge transfer pump 325 (a 10 GPM double diameter air operated pump) to sludge dewatering system 800, which is a 2 cubic foot filter press in this embodiment. Sludge thickener recycle stream 750 may be drained or recycled along with dewatering system recycle stream 850 and sludge dewatering recycle stream 330 to the clarifier (solids/liquid separation system 300). Solids/liquid separation system process stream 350 is sent via UF pump 320 at 21.5 GPM to UF system 400. Sludge cake is removed for collection/disposal handling, e.g., landfill disposal, at 860.

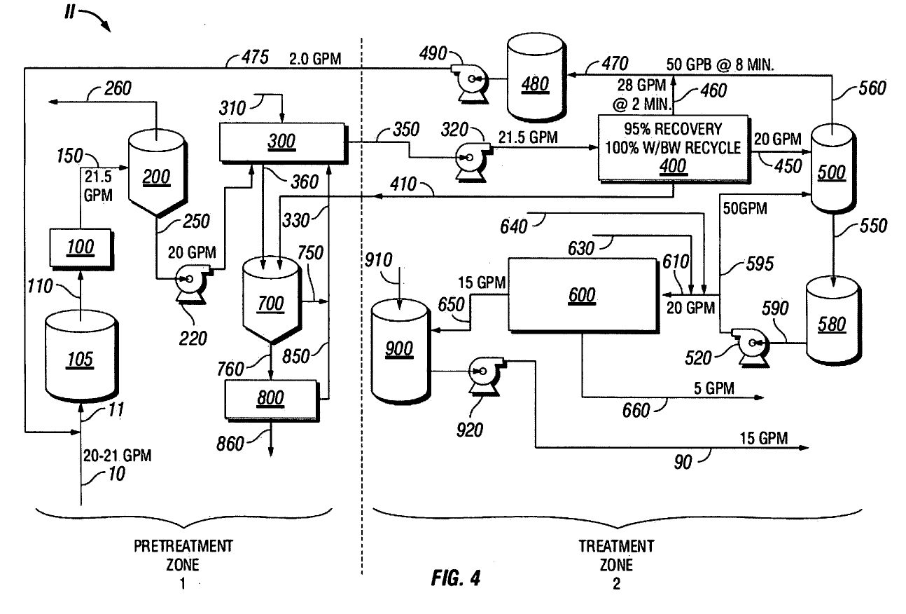

Following pretreatment zone 1, the water treatment system of the present disclosure comprises a treatment zone comprising a membrane treatment system. In the exemplary pilot plant II of FIG. 2, the membrane treatment system comprises ultrafiltration system 400, GAC filtration system 500, and NF/RO system 600. Referring now to FIG. 6 which is a flow diagram of treatment zone 2 of the water treatment system of the pilot plant II, solids/liquid separation system process stream 350 is introduced into ultrafiltration system 400, which (as further shown in FIG. 4) comprises a 21.5 GPM system designed for 93% to 95% recovery. With backwash recycle, the recovery may near 100%. UF fluid process stream 450 flows, in this arrangement into membrane separation system feed tank 580 which comprises the RO system feedwater and GAC filter backwash water holding tank. Membrane separation system feed tank 580 is a 500 gallon HDPE tank. In this embodiment membrane separation system feed tank exit stream 555 flows via membrane separation system feed tank pump 520 (RO system feed/GAC B/W pump) to GAC filtration system 500.

UF backwash stream 460 and GAC backwash stream 560 enter B/W Holding Tank 480 (comprising GAC backwash water and UF backwash water) which is a 500 gallon HDPE tank. Backwash recycle pump 490 pumps backwash recycle stream 475 back to pretreatment zone 1 where backwash recycle stream 475 combines with feed water stream 10. Backwash of the UF membranes and the GAC filter may be performed in any manner as is known to one of skill in the art. For example, UF system 400 may be run for a period of time, e.g., 45 minutes to an hour, and then backwashed, for example at 28 gal/min for 2 minutes. The carbon filter of GAC filtration system 500 may be periodically backwashed, for example, once every 3 to 7 days at a flow rate of about 50 gal/min for a time period in the range of from about 5 minutes to about 6 minutes.

Membrane separation system inlet stream 610 at 20 GPM enters membrane separation system 600, here an RO system. Antiscalant stream 630 and pH adjustment stream 640 may be used to control scaling and pH in the NF/RO system 600. In the pilot plant, RO system 600 is designed for 75% recovery.

Membrane separation system reject stream 660 leaves pilot plant II at 5 GPM. Membrane separation system permeate stream 650, comprising permeate from the RO system and having a 15 GPM flow rate, enters SAR adjustment system 900, wherein, through the addition of calcium oxide or calcium hydroxide via SAR adjustment stream 910, the SAR is adjusted to less than 3. In the pilot plant, SAR adjustment system 900 is a 500 gallon HDPE tank.

Finished water stream 90 exits the water treatment system of pilot plant II via RO pressure pump 920 at 15 GPM.

U.S. patent application Ser. No. 11/588,756 is hereby incorporated herein by reference to the extent not inconsistent with the disclosure herein, including for useful filtration modules, filter elements, and methods. When a group of substituents is disclosed herein, it is understood that all individual members of those groups and all subgroups are disclosed separately. When a Markush group or other grouping is used herein, all individual members of the group and all combinations and subcombinations possible of the group are intended to be individually included in the disclosure.

While preferred embodiments of the methods have been shown and described, modifications thereof can be made by one skilled in the art without departing from the spirit and teachings of the present disclosure. The embodiments described herein are exemplary only, and are not intended to be limiting. Many variations and modifications of the methods disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the present disclosure. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method for the removal of contaminants from a contaminated water stream, the method comprising:
pretreating the contaminated water stream to yield a pretreated water stream, wherein pretreating comprises passing the contaminated water stream to at least one electrocoagulation cell wherein coagulation of contaminants is promoted, yielding an electrocoagulated stream; and separating coagulated contaminants from the electrocoagulated stream.

2. The method of claim 1 further comprising treating the pretreated water stream to yield a purified water stream, wherein treating comprises passing the pretreated water stream through at least one membrane separator.

3. The method of claim 2 wherein the overall recovery of purified water is greater than 25 volume % of the contaminated water stream.

4. The method of claim 2 wherein passing the pretreated water stream through at least one membrane separator comprises passing the pretreated water stream through an ultrafiltration membrane separator comprising at least one ultrafiltration membrane to yield an ultrafiltrate stream.

5. The method of claim 4 further comprising periodically backwashing the at least one ultrafiltration filter, yielding an ultrafiltration backwash stream.

6. The method of claim 5 further comprising recycling the ultrafiltration backwash stream to the at least one electrocoagulation cell.

7. The method of claim 4 further comprises passing the ultrafiltrate stream through a GAC filter to yield a GAC filtrate stream.

8. The method of claim 7 further comprising periodically backwashing the GAC filter, yielding a GAC backwash stream.

9. The method of claim 8 further comprising recycling the GAC backwash stream to the at least one electrocoagulation cell.

10. The method of claim 7 further comprising passing the GAC filtrate stream through at least one membrane separator.

11. The method of claim 10 wherein the at least one membrane separator is selected from the group consisting of nanofiltration separators, reverse osmosis membrane separators, and combinations thereof.

12. The method of claim 1 wherein the contaminated water stream is selected from the group consisting of oilfield produced waters, industrial wastewater, process waters, and combinations thereof.

13. The method of claim 1 wherein the method is used for the large scale removal of contaminants from the contaminated water stream.

14. The method of claim 1 wherein the at least one membrane separator is selected from the group consisting of ultrafiltration membrane separators, GAC filters, reverse osmosis separators, nanofiltration separators, and combinations thereof.

15. The method of claim 1 wherein removal of the contaminants from the contaminated water stream is accomplished in the absence of chemical clarification.

16. The method of claim 1 wherein pretreating further comprises at least one step selected from the group consisting of: deaerating the electrocoagulated stream, flotating coagulated contaminants, flocculating coagulated contaminants, and combinations thereof.

17. The method of claim 1 wherein separating coagulated contaminants from the electrocoagulated stream comprises passing the electrocoagulated stream through a solids/liquid separator.

18. The method of claim 17 wherein the solids/liquid separator is a parallel plate clarifier.

19. The method of claim 1 further comprising providing at least two electrocoagulation cells, wherein each of the at least two electrocoagulation cells has 100% capacity and wherein one of the at least two electrocoagulation cells is online when another of the at least two electrocoagulation cells is offline, and wherein passing the contaminated water stream to at least one electrocoagulation cell comprises passing the contaminated water stream to the online electrocoagulation cell.

20. The method of claim 19 further comprising periodically performing an automated cleaning cycle of the online electrocoagulation cells comprising:
placing the electrocoagulation cell to be cleaned offline;
placing one of the at least one offline electrocoagulation cells online; and
placing the electrocoagulation cell to be cleaned in an automated cleaning cycle.

21. The method of claim 1 wherein the at least one electrocoagulation cell comprises at least one system selected from the group consisting of air distribution systems, internal flow distribution systems, internal process fluid recirculation systems, and combinations thereof.

22. The method of claim 1 further comprising providing instrumentation for the monitoring and automatic control of the at least one electrocoagulation cell.

23. The method of claim 22 further comprising providing instrumentation for control of at least one operational parameter selected from the group consisting of: automated DC voltage control, polarity reversal of the electrodes in the at least one electrocoagulation cell, recirculation of the process liquid, initiation and control of cleaning cycles, control of inlet feed flow rate, and combinations thereof.

24. The method of claim 22 comprising providing instrumentation for monitoring at least one process parameter selected from the group consisting of: inlet feed flow rate to the at least one electrocoagulation cell, fluid conductivity of the inlet feed to the at least one electrocoagulation cell, fluid turbidity of the inlet feed to the at least one electrocoagulation cell, inlet fluid temperature of the inlet fluid to the at least one electrocoagulation cell, ORP of the inlet fluid to the at least one electrocoagulation cell, ORP of the effluent from the at least one electrocoagulation cell, pH of the inlet fluid to the at least one electrocoagulation cell, pH of the effluent from the at least one electrocoagulation cell, cell current, cell voltage, and combinations thereof.

25. An electrocoagulation reactor comprising:
a plurality of electrodes positioned parallel to each other and provided with a means of energizing each electrode;
a fluid inlet for an inlet stream comprising contaminated water;
a fluid outlet for an outlet stream comprising electrocoagulated products;
a flow distributor system; and
a gas distribution system for injecting a gas into the electrocoagulation reactor.

26. The reactor of claim 25 further comprising an internal process fluid recirculation loop.

27. An electrocoagulation system for treating a contaminated water stream, the system comprising:
at least one electrocoagulation reactor according to claim 25.

28. The electrocoagulation system of claim 27 further comprising at least one membrane separator selected from the group consisting of ultrafiltration membrane separators, GAC filters, reverse osmosis separators, nanofiltration separators, and combinations thereof, and wherein the at least one membrane separator comprises an inlet for the pretreated water stream and a membrane separator outlet for a membrane separator outlet stream.

29. The electrocoagulation system of claim 28 wherein the at least one membrane separator comprises an ultrafiltration membrane separator, wherein the ultrafiltration membrane separator comprises at least one ultrafiltration membrane, and wherein the membrane separator outlet stream is an ultrafiltrate stream.

30. The electrocoagulation system of claim 29 further comprising a GAC filter comprising an inlet for the ultrafiltrate stream and an outlet for a GAC filtrate stream.

31. The electrocoagulation system of claim 30 further comprising at least one membrane separator having an inlet for the GAC filtrate stream and an outlet for the purified water stream.

32. The electrocoagulation system of claim 31 wherein the purified water stream comprises at least 25 volume percent of the contaminated water stream.

33. The electrocoagulation system of claim 27 further comprising a separator for separating coagulated products from the outlet stream to produce a pretreated water stream.

34. The electrocoagulation system of claim 33 wherein the separator is a clarifier.

35. An electrocoagulation system for treating a contaminated water stream, the system comprising: at least two electrocoagulation reactors according to claim 25 having an operating voltage range for promoting coagulation reactions within the contaminated water stream;
wherein when one electrocoagulation reactor is online and has a measured operating voltage, the second electrocoagulation reactor is offline, and
wherein the offline electrocoagulation reactor is placed online and the online electrocoagulation reactor is placed offline for cleaning when the measured operating voltage is not within the operating voltage range.

36. The electrocoagulation system of claim 35 further comprising an automated clean-in-place system.
